(19) United States
(12) Patent Application Publication
(10) Pub. No.: US 2017/0052547 A1
(43) Pub. Date: Feb. 23, 2017

(54) Hand-adjustable float valve anh methods

(71) Applicant: Robert Courtney Thomson, Orland, CA (US)

(72) Inventor: Robert Courtney Thomson, Orland, CA (US)

(21) Appl. No.: 15/230,408

(22) Filed: Aug. 6, 2016

Related U.S. Application Data
(60) Provisional application No. 62/206,429, filed on Aug. 18, 2015.

(51) Int. Cl. G05D 9/02; F16K 31/18

(52) U.S. Cl. CPC G05D 9/02; F16K 31/18

(57) ABSTRACT

A hand-adjustable float valve for easily adjusting the water level of a body of water, such as a pool, without the use of tools is disclosed. Namely, the hand-adjustable float valve includes a valve assembly, a float assembly, and a hand-adjusting assembly. A method is provided of using the hand-adjustable float valve to adjust the water level of a pool without the use of tools may include, but is not limited to, the steps of loosening by hand the locking nut of the hand-adjustable float valve, setting by hand the water level of the pool using the hand-adjusting assembly to adjust the float assembly, and tightening by hand locking nut of the hand-adjustable float valve.

### TECHNICAL FIELD

The presently disclosed subject matter relates generally to float valves (aka autofill valves) for swimming pools and more particularly to a hand-adjustable float valve and methods for easily adjusting the water level of a body of water, such as a pool, without the use of tools.

### BACKGROUND

Currently, there are a number of devices for automatically maintaining water in a swimming pool at a desired level. Most of the devices include a float valve located in a water chamber adjacent to the pool. The interior of the chamber is in open fluid communication with the pool, so that the surface of water in the chamber is at the same level as the water surface of the pool. A mechanical, magnetic, or electronic sensor adjacent to the pool detects the level of a float and in response thereto water from a water supply line is metered into the pool until the desired water level has been reached.

There are certain drawbacks to current devices for maintaining the water level is a pool. In one example, current float valves may require the use of tools to adjust the position of a float tank for setting the desired water level. Unfortunately, the water chamber or reservoir in which the float valve is installed is typically quite small, which makes it difficult to fit tools therein for adjusting the float valve. Further, because the float adjusting process can be difficult, the adjusting process likely requires a trained pool technician and is not well suited to be performed by the pool owner. Therefore, new approaches are needed for adjusting devices, such as float valves, that are used for maintaining the water level of a body of water, such as a pool.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a perspective view of an example of the presently disclosed hand-adjustable float valve for easily adjusting the water level of, for example, a swimming pool without the use of tools;

FIG. 2 illustrates a side view of an example of the presently disclosed hand-adjustable float valve installed in a pool system;

FIG. 3A and FIG. 3B show perspective views of a valve assembly of the presently disclosed hand-adjustable float valve;

FIG. 4 shows a perspective view of an example of a fastener of the valve assembly of the presently disclosed hand-adjustable float valve;

FIG. 5 shows a perspective view of an example of an arm of the valve assembly of the presently disclosed hand-adjustable float valve;

FIG. 6 shows perspective views of an example of a float tank of the presently disclosed hand-adjustable float valve;

FIG. 7 shows a perspective view of an example of a float arm of the presently disclosed hand-adjustable float valve;

FIG. 8 and FIG. 9 show an exploded view and a perspective view, respectively, of an example of a hand-adjusting assembly of the presently disclosed hand-adjustable float valve;

FIG. 10 shows a perspective view of an example of an adjustment bolt of the hand-adjusting assembly of the presently disclosed hand-adjustable float valve;

FIG. 11 shows perspective views of an example of a bolt cap of the hand-adjusting assembly of the presently disclosed hand-adjustable float valve;

FIG. 12 shows perspective views of an example of a locking nut and of a locking nut grip of the hand-adjusting assembly of the presently disclosed hand-adjustable float valve;

FIG. 13A and FIG. 13B show perspective views of two examples of an adjustment arm of the hand-adjusting assembly of the presently disclosed hand-adjustable float valve;

FIG. 13C shows an example of the dimensions of the adjustment arm of the hand-adjusting assembly of the presently disclosed hand-adjustable float valve;

FIG. 14 and FIG. 15 show two different exploded views of the presently disclosed hand-adjustable float valve;

FIG. 16 shows a side view of the presently disclosed hand-adjustable float valve when in use;

FIG. 17 illustrates a flow diagram of an example of a method of installing the presently disclosed hand-adjustable float valve; and

FIG. 18 illustrates a flow diagram of an example of a method of using the presently disclosed hand-adjustable float valve to easily adjust the water level of a pool without the use of tools.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a hand-adjustable float valve and methods for easily adjusting the water level of a body of water, such as a pool, without the use of tools. Namely, the hand-adjustable float valve includes a valve assembly, a float assembly, and a hand-adjusting assembly. The hand-adjusting assembly is used for setting the position of the float assembly with respect to the fixed position of the valve assembly and the surface of the water. Namely, the hand-adjusting assembly includes an adjustment bolt for setting the position of the float assembly, wherein the adjustment bolt can be adjusted easily by hand without the use of tools. Additionally, a method is provided of installing the presently disclosed hand-adjustable float valve. Further, a method is provided of using the presently disclosed hand-adjustable float valve to easily adjust the water level of a pool without the use of tools.

Accordingly, an aspect of the presently disclosed hand-adjustable float valve is that it can be used to set the level of a body of water, such as a pool, wherein the water level can be set by hand without the use of tools.

Another aspect of the presently disclosed hand-adjustable float valve is that it can be easily retrofitted to existing pool systems.

Yet another aspect of the presently disclosed hand-adjustable float valve is that because it can be easily adjusted by hand it allows untrained individuals, such as pool owners, to set the water level of their own pool. Accordingly, using the presently disclosed hand-adjustable float, pool owners can avoid the expense of hiring a pool professional to adjust the water level of their pool.

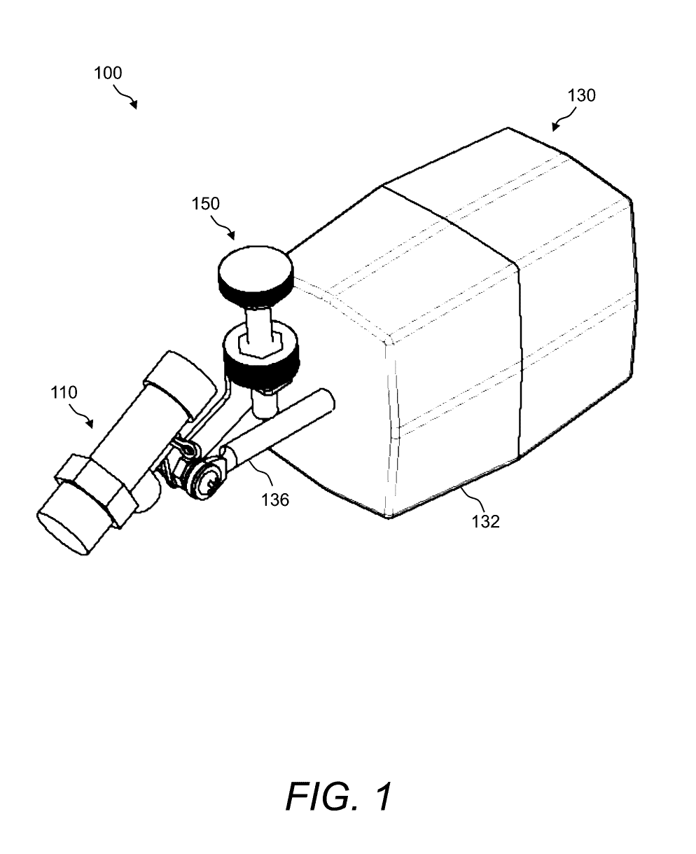

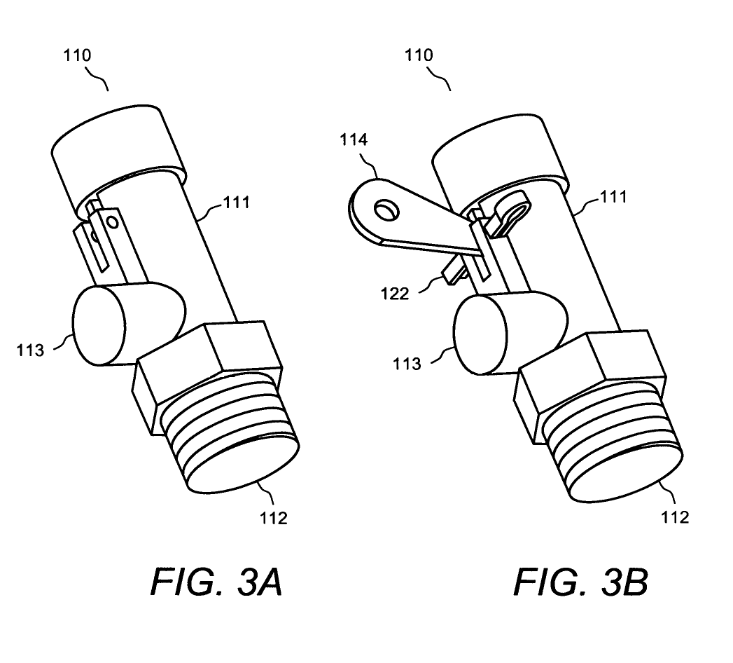

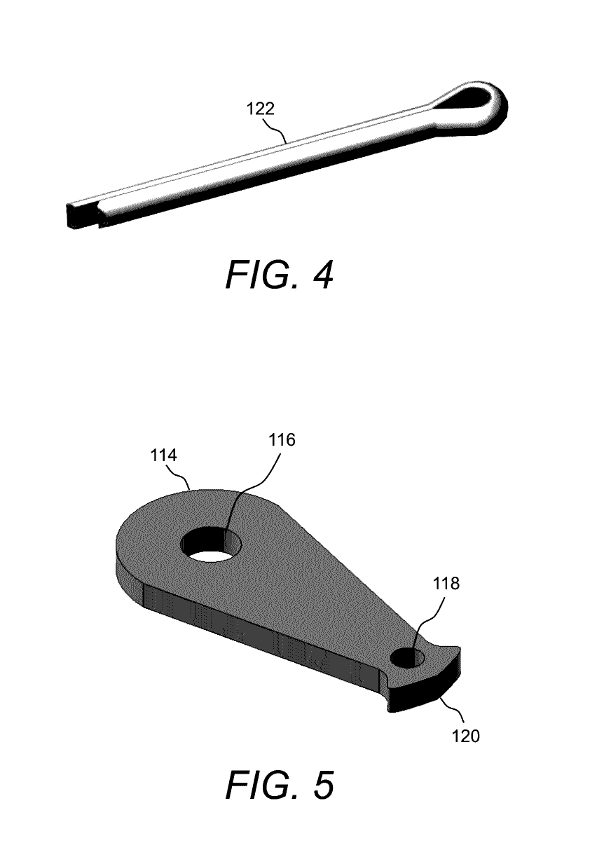

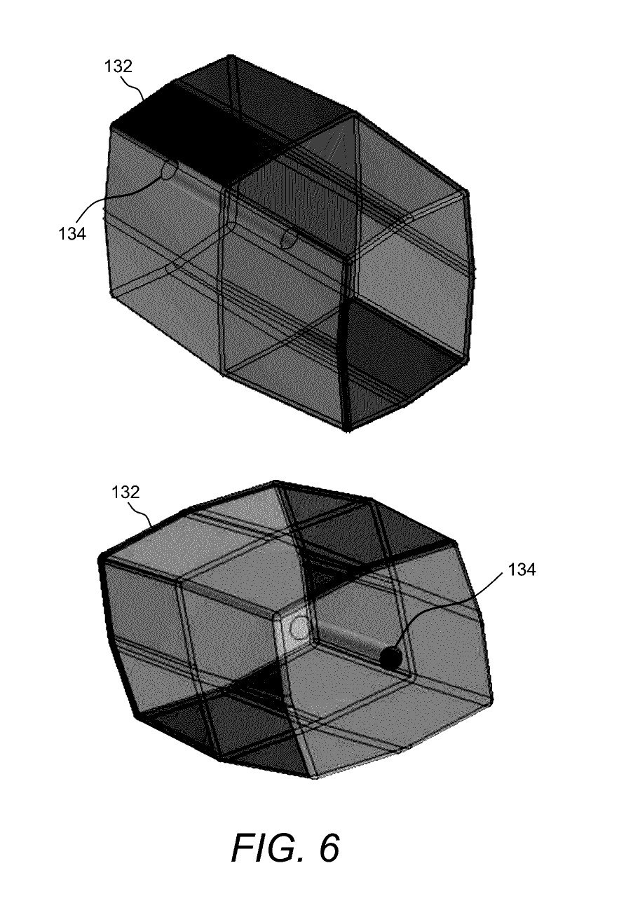

Referring now to FIG. 1 is a perspective view of an example of the presently disclosed hand-adjustable float valve 100 for easily adjusting the water level of, for example, a swimming pool without the use of tools. In this example, the hand-adjustable float valve 100 includes a valve assembly 110, a float assembly 130, and a hand-adjusting assembly 150. The valve assembly 110 can be based on any standard float valve used, for example, in pool systems. In one state, the valve assembly 110 is closed and no water passes therethrough. In another state, the valve assembly 110 is open and water passes therethrough. More details of the components of the valve assembly 110 are shown and described hereinbelow with respect to FIG. 3A, FIG. 3B, FIG. 4, and FIG. 5.

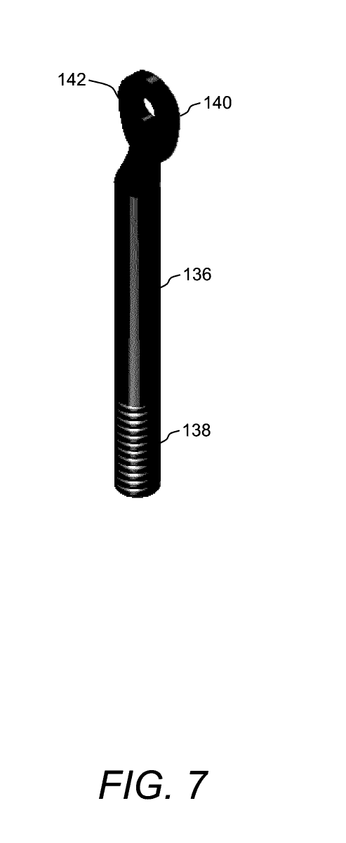

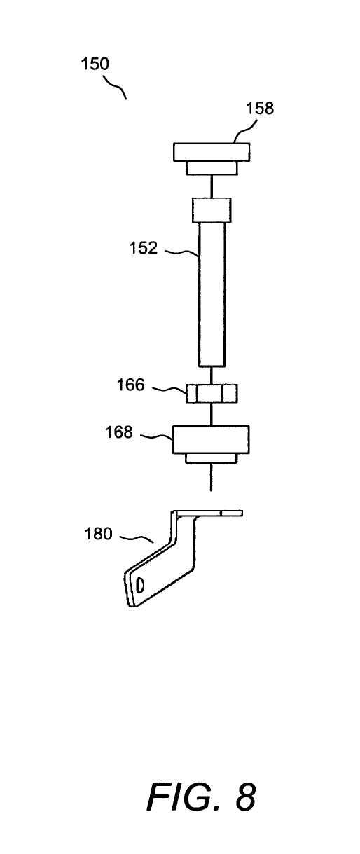

The float assembly 130 includes a float tank 132 and a float arm 136. The float assembly 130 controls the state of the valve assembly 110. Namely, the position of the valve assembly 110 is fixed while the position of the float assembly 130 varies with changing water levels. Accordingly, depending on the position of the float assembly 130 with respect to the position of the valve assembly 110, the valve assembly 110 is either closed (i.e., no water flowing therethrough) or open (i.e., water flowing therethrough). More details of the components of the float assembly 130 are shown and described hereinbelow with respect to FIG. 6 and FIG. 7.

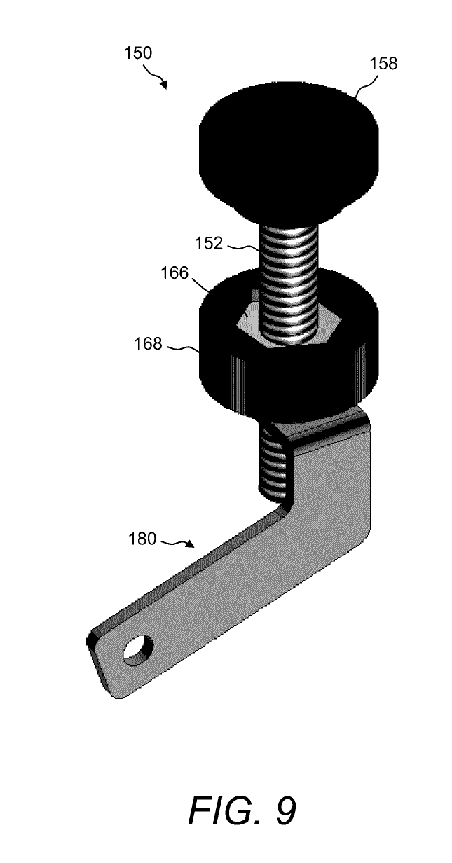

The hand-adjusting assembly 150 allows the user to set by hand (without tools), the trigger point of the valve assembly 110; namely, the position of the float assembly 130 with respect to the water level and with respect to the valve assembly 110 for opening/closing the valve assembly 110 to maintain the desired water level. More details of the components of the hand-adjusting assembly 150 are shown and described hereinbelow with respect to FIG. 8 through FIG. 13B.

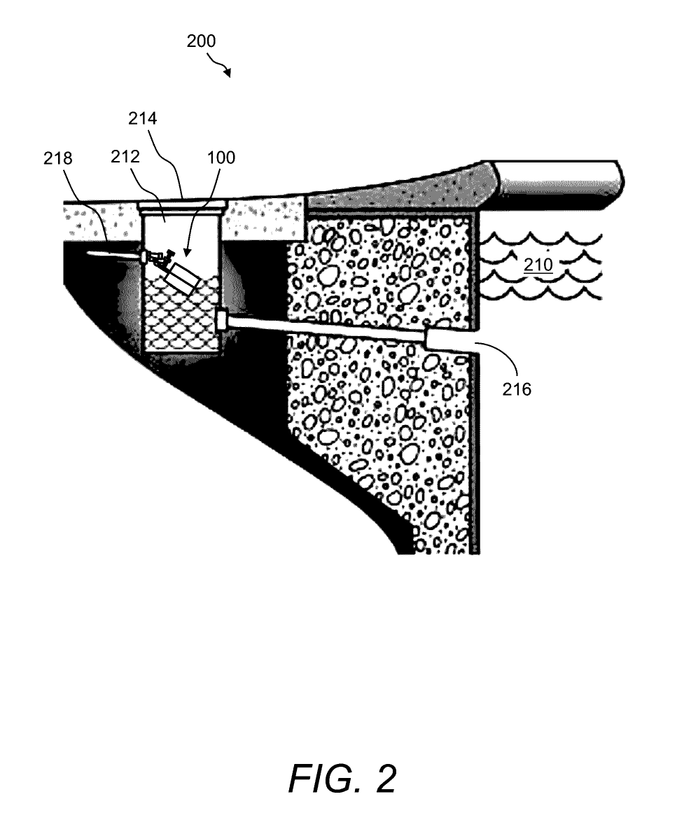

Referring now to FIG. 2 is a side view of an example of the presently disclosed hand-adjustable float valve 100 installed in a pool system. Namely, FIG. 2 shows a pool system 200, which can be, for example, any standard swimming pool system. Pool system 200 includes a main body of water 210. A float chamber or reservoir 212 is located outside of, but in close proximity to, the main body of water 210. The float chamber or reservoir 212 may have a cover 214. In one example, the float chamber or reservoir 212 is a cylinder-shaped reservoir that is about 8-10 inches in diameter and about 12 inches deep.

The float chamber or reservoir 212 and the main body of water 210 are fluidly connected via a pressure equalizer line 216. The pressure equalizer line 216 connects to a lower portion of the float chamber or reservoir 212. The pressure equalizer line 216 may be angled downward slightly from the float chamber or reservoir 212 to the main body of water 210, which encourages water flow by gravity from the float chamber or reservoir 212 to the main body of water 210. A water supply line 218 is connected to an upper portion of the float chamber or reservoir 212. Further, the water supply line 218 supplies an inlet of the valve assembly 110 of the hand-adjustable float valve 100.

Referring now to FIG. 3A and FIG. 3B are perspective views of the valve assembly 110 of the presently disclosed hand-adjustable float valve 100. The valve assembly 110 includes a valve housing 111, in which a valve mechanism (not visible) is installed. An inlet 112 is at one end of the valve housing 111, while the opposite end is capped off. An outlet 113 is provided on one side of the valve housing 111 in a T-type configuration. The inlet 112 is threaded for easy connection to a water source, such as to water supply line 218 of pool system 200 shown in FIG. 2. The valve mechanism (not visible) inside the valve housing 111 controls the flow of water from the inlet 112 to the outlet 113. Namely, when the valve mechanism is closed, water cannot flow through valve housing 111 and thus water cannot exit the outlet 113. However, when the valve mechanism is open, water can flow through the valve housing 111 and thus water can exit the outlet 113. The valve assembly 110 includes an arm 114, which is the component that controls the state of the valve mechanism inside the valve housing 111. The valve housing 111 includes a slot for receiving the end of the arm 114 that is mechanically coupled to the valve mechanism (not visible). The arm 114 is held to the valve housing 111 via a fastener 122. In one example, the fastener 122 is a cotter pin, as shown in FIG. 4. However, the fastener 122 can be any type of fastener, such as a screw, a bolt, any type of pin, any type of clip, a tie, and the like. FIG. 3A shows the valve assembly 110 absent the arm 114 and the fastener 122, while FIG. 3B shows the valve assembly 110 with the arm 114 and the fastener 122 installed.

The components of the valve assembly 110 (e.g., the valve housing 111, the arm 114, and the fastener 122) can be formed of any lightweight rigid material, such as, but not limited to, plastic, stainless steel, aluminum, and/or any combinations thereof.

FIG. 5 shows a perspective view of an example of the arm 114 of the valve assembly 110. In this example, the arm 114 is a flat member that has a teardrop-shaped footprint. There is an opening 116 at the large end of the arm 114 and an opening 118 at the small end of the arm 114. The opening 116 and the opening 118 are through holes in the flat member. The opening 116 is sized to receive a coupler of the hand-adjusting assembly 150. The opening 118 is sized to receive the fastener 122. Further, a rocker feature 120 is provided at the tip of the small end of the arm 114. The rocker feature 120 is designed to mechanically engage with the valve mechanism (not visible) inside the valve housing 111. Namely, the rocker feature 120 engages with the valve mechanism to actuate (open and close) the valve mechanism. In one example, the arm 114 is about ¾ inches long, about ¼ inches wide, and about 1/16 inches thick.

Referring now to FIG. 6 is perspective views of an example of the float tank 132 of the float assembly 130 of the presently disclosed hand-adjustable float valve 100. An opening 134 is provided at one end of the float tank 132. The opening 134 is designed to receive the threaded end (see FIG. 7) of the float arm 136. The float tank 132 is a lightweight hollow member that can be formed, for example, of plastic. In one example, the float tank 132 is about 3½ inches long, about 2½ inches wide, and about 2 inches high. FIG. 7 shows a perspective view of an example of the float arm 136. One end of the float arm 136 is threaded (i.e., threads 138). A fastening tab 140 (e.g., a flattened member) is provided at the opposite end of the float arm 136. An opening 142 (i.e., a through hole) is provided in the fastening tab 140 of the float arm 136. The opening 142 is designed to receive a coupler of the hand-adjusting assembly 150. The float arm 136 can be formed of any lightweight rigid material, such as, but not limited to, plastic, stainless steel, and aluminum. In one example, the float arm 136 has a diameter of about 3/16 inches and an overall length of about 2½ inches.

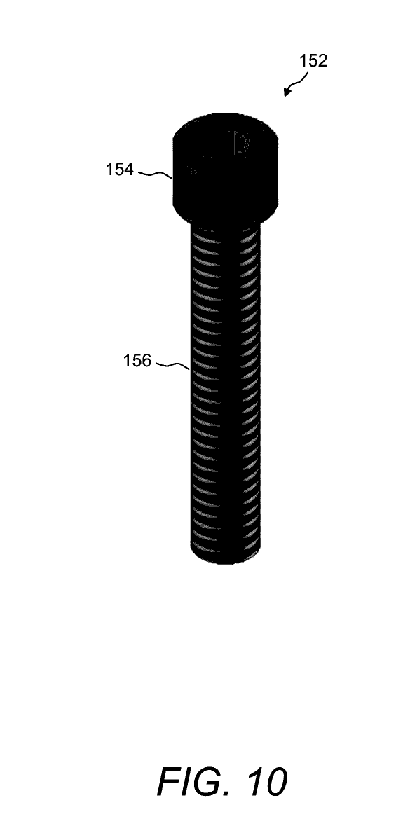

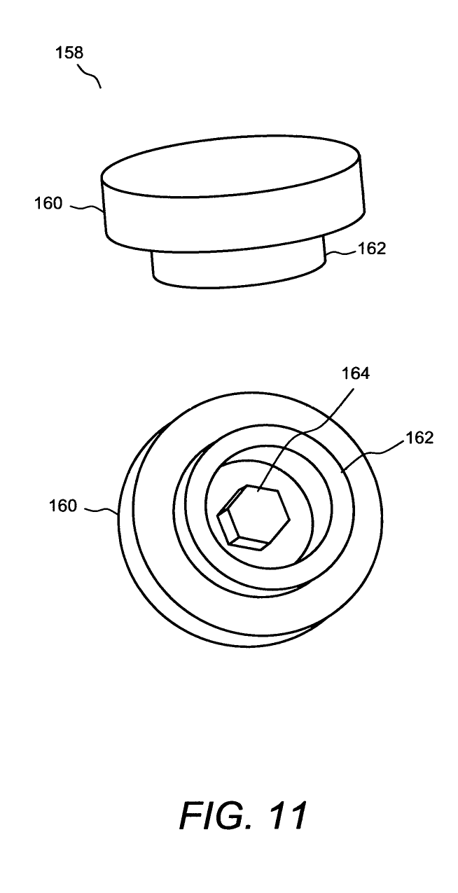

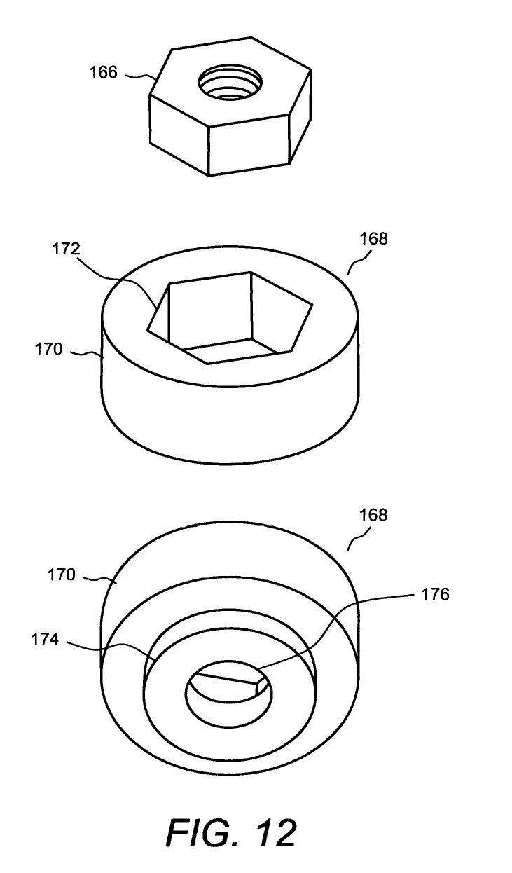

Referring now to FIG. 8 and FIG. 9 is an exploded view and a perspective view, respectively, of an example of the hand-adjusting assembly 150 of the presently disclosed hand-adjustable float valve 100. In this example, the hand-adjusting assembly 150 includes an adjustment bolt 152, wherein the adjustment bolt 152 includes a head portion 154 and a threaded portion 156 as shown for example in FIG. 10. The hand-adjusting assembly 150 further includes an adjustment knob 158 that is designed to be press-fitted atop the head portion 154 of the adjustment bolt 152. The adjustment knob 158 includes a grip portion 160, a receiving portion 162, and an engaging feature 164 as shown for example in FIG. 11. Namely, the receiving portion 162 of the adjustment knob 158 is designed to be press-fitted atop the head portion 154 of the adjustment bolt 152, wherein the engaging feature 164 corresponds to a feature in the head portion 154 of the adjustment bolt 152. In so doing, the head portion 154 of the adjustment bolt 152 is surrounded by the grip portion 160, whereby the grip portion 160 can be used to turn by hand the adjustment bolt 152.

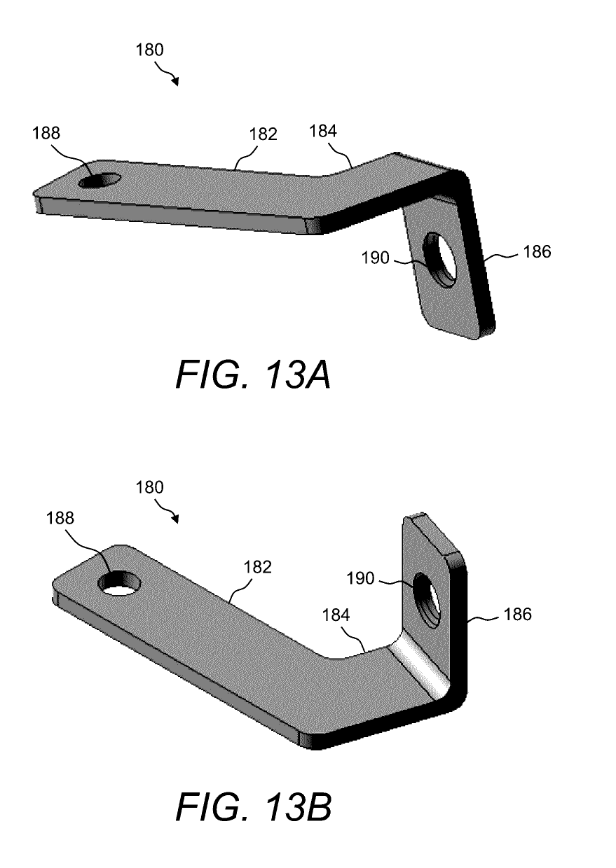

The hand-adjusting assembly 150 further includes a locking nut 166 that is fitted into a locking nut holder 168, wherein the locking nut holder 168 includes a grip portion 170, a receiving portion 172, a mating portion 174, and a clearance hole 176 as shown for example in FIG. 12. Namely, the locking nut 166 is fitted into the receiving portion 172 of the locking nut holder 168. In so doing, the locking nut 166 is surrounded by the grip portion 170, whereby the grip portion 170 can be used to turn by hand the locking nut 166. The adjustment bolt 152 passes through the clearance hole 176 of the mating portion 174.

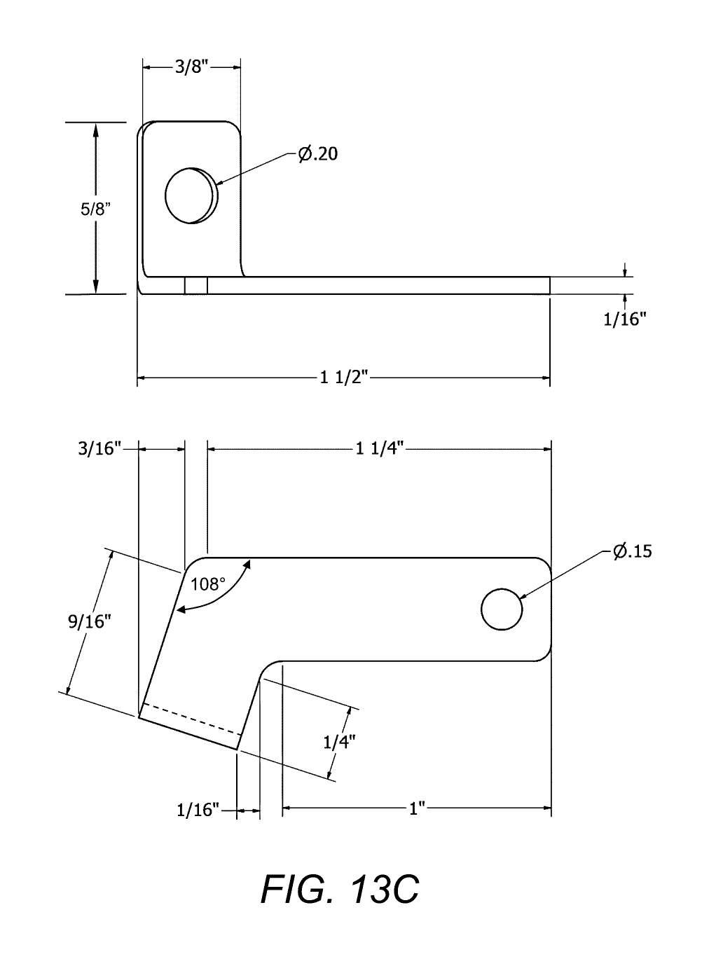

The hand-adjusting assembly 150 further includes an adjustment arm 180, wherein the adjustment arm 180 includes a first segment 182, a second segment 184, and a third segment that is hereafter called the locking plate 186, as shown for example in FIG. 13A, FIG. 13B, and FIG. 13C. Namely, FIG. 13A and FIG. 13B show perspective views of two examples of the adjustment arm 180 of the hand-adjusting assembly 150 of the presently disclosed hand-adjustable float valve 100, while FIG. 13C shows one example of the dimensions of the adjustment arm 180.

In both examples, the adjustment arm 180 is a flat member that includes the three segments. The first segment 182 is the longest segment. An opening 188 is provided at one end of the first segment 182. The second segment 184 extends from the other end of the first segment 182 and in the same plane as the first segment 18, but at an angle. In one example, the angle is about 108 degrees. The locking plate 186 extends substantially orthogonally from the second segment 184 as shown. Namely, FIG. 13A shows the locking plate 186 extending in one direction from the second segment 184, while FIG. 13B shows the locking plate 186 extending in the opposite direction from the second segment 184. In both cases, a threaded hole 190 is provided in the locking plate 186. The threaded hole 190 in the locking plate 186 is designed to receive the adjustment bolt 152. By way of example, the hand-adjusting assembly 150 shown in FIG. 8 is using the adjustment arm 180 shown in FIG. 13B, while the hand-adjusting assembly 150 shown in FIG. 9 is using the adjustment arm 180 shown in FIG. 13A.

The adjustment bolt 152, the adjustment knob 158, the locking nut 166, the locking nut holder 168, and the adjustment arm 180, can be formed of any lightweight rigid material, such as, but not limited to, plastic, stainless steel, aluminum, and/or any combinations thereof.

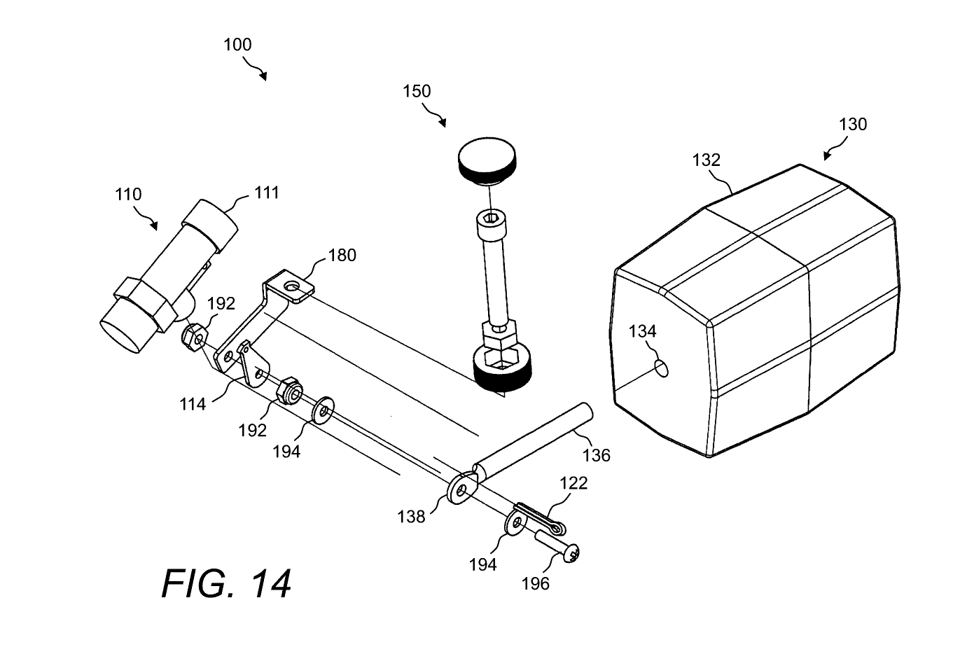

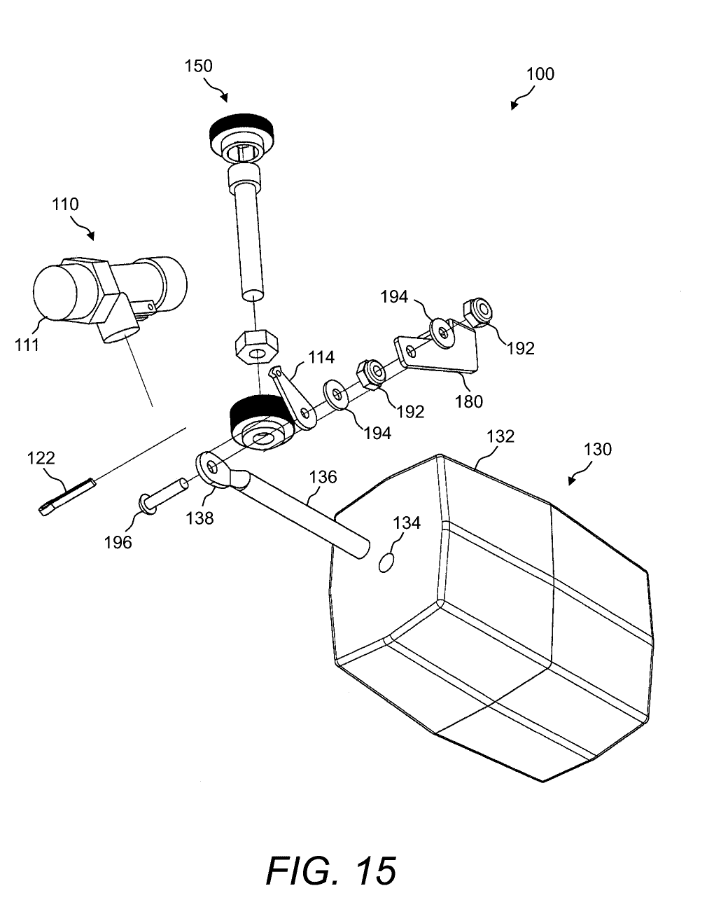

Referring now to FIG. 14 and FIG. 15 are two different exploded views of the presently disclosed hand-adjustable float valve 100. Namely, FIG. 14 and FIG. 15 show exploded views of the all the components of the valve assembly 110, the float assembly 130, and the hand-adjusting assembly 150, as well as two nuts 192, two washers 194, and a bolt 196 for coupling the valve assembly 110, the float assembly 130, and the hand-adjusting assembly 150 together.

The valve assembly 110, the float assembly 130, and the hand-adjusting assembly 150 are coupled together at a common hinge or pivot point. More particularly, the opening 116 in the arm 114 of the valve assembly 110 is the common hinge or pivot point. Namely, the opening 142 in the fastening tab 140 of the float arm 136 of the float assembly 130 is aligned on one side with the opening 116 in the arm 114 the valve assembly 110. Similarly, the opening 188 in the adjustment arm 180 of the hand-adjusting assembly 150 is aligned on the other side with the opening 116 in the arm 114 the valve assembly 110. Then, the bolt 196 passes through the opening 142 in the fastening tab 140 of the float arm 136 of the float assembly 130, the opening 116 in the arm 114 the valve assembly 110, and the opening 188 in the adjustment arm 180 of the hand-adjusting assembly 150 to form the hinge or pivot point. As shown in FIG. 14 and FIG. 15, the hinge or pivot point also includes the arrangement of two nuts 192 and two washers 194 along the bolt 196 for holding the assembly together.

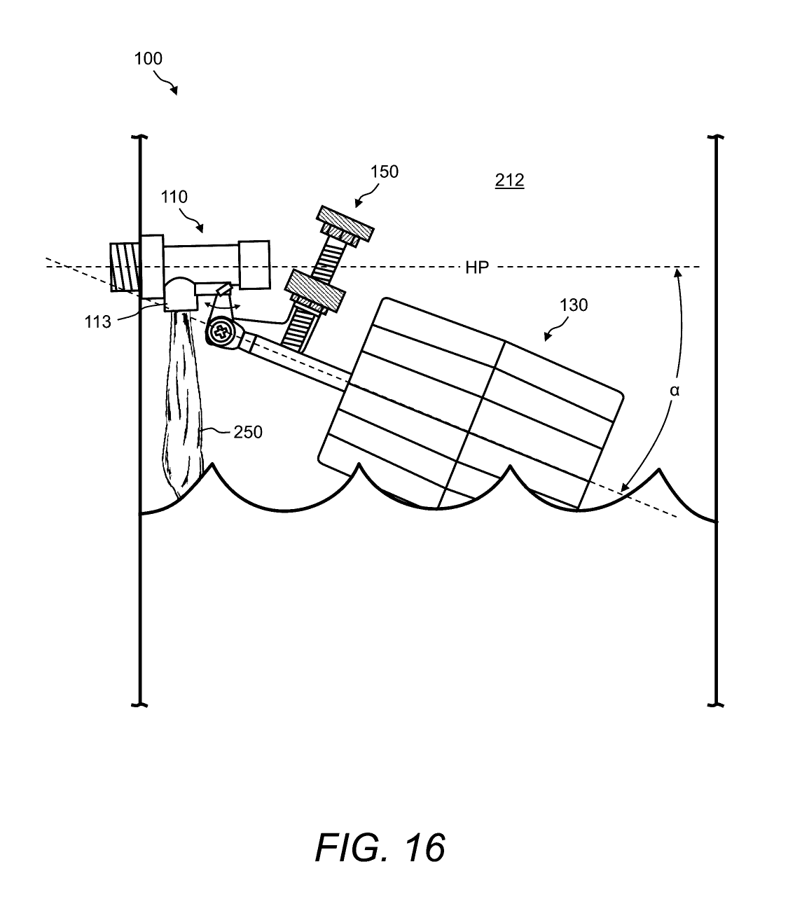

Referring now to FIG. 16 is a side view of the presently disclosed hand-adjustable float valve 100 when in use. For example, FIG. 16 shows the hand-adjustable float valve 100 installed in the float chamber or reservoir 212 of the pool system 200 shown in FIG. 2. The inlet 112 of the valve assembly 110 is threaded into the side wall (and into the end of the water supply line 218) of the float chamber or reservoir 212. In so doing, the position of the valve assembly 110 is fixed with respect to the surface of the water inside the float chamber or reservoir 212. Namely, the longitudinal axis of the valve housing 111 of the valve assembly 110 is installed along a horizontal plane (HP), which is substantially parallel to the plane of the surface of the water inside the float chamber or reservoir 212.

The adjustment bolt 152 is preset a certain distance through the adjustment arm 180 of the hand-adjusting assembly 150, wherein the tip of adjustment bolt 152 can come into contact with the float arm 136 of the float assembly 130. For example, the adjustment bolt 152 is used to set a desired angel a of the float assembly 130 with respect to horizontal plane (HP) of the valve assembly 110 for achieving the desired water level.

Keep in mind that one end of the arm 114 is moveable for actuating the valve assembly 110 and that both the float assembly 130 and the hand-adjusting assembly 150 are moveable about the common hinge or pivot point at the other end of the arm 114 of the valve assembly 110. In operation, with rising water level, the float assembly 130 moves up, the valve assembly 110 is closed, and the water is turned off. However, with lowering water level, the float assembly 130 moves down, the valve assembly 110 is opened, and the water is turned on. By way of example, FIG. 16 shows the float assembly 130 open and water 250 dispensing from the outlet 113 and into the float chamber or reservoir 212. Water will continue to dispense until the water level has risen enough to close the valve assembly 110 via the preset float assembly 130.

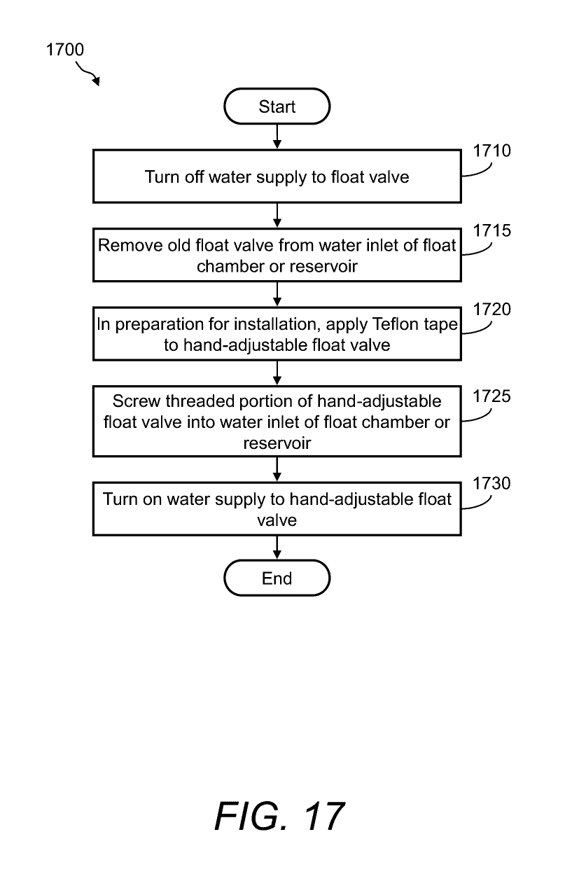

Referring now to FIG. 17 is a flow diagram of an example of a method 1700 of installing the presently disclosed hand-adjustable float valve 100. The method 1700 may include, but is not limited to, the following steps.

At a step 1710, the water supply to the existing float valve is turned off. For example, the water supply line 218 to the float chamber or reservoir 212 of the pool system 200 shown in FIG. 2 is turned off.

At a step 1715, the old float valve is removed from the water inlet of the float valve reservoir. For example, the old float valve is unscrewed from the end of the water supply line 218 of the float chamber or reservoir 212 of the pool system 200. Note that if a float valve is not already present in the float chamber or reservoir 212, this step is omitted from the method 1700.

At a step 1720, in preparation for installation, Teflon® tape is applied to the hand-adjustable float valve 100. More particularly, Teflon® tape is applied to the threads of the inlet 112 of the valve housing 111 of the valve assembly 110 of the hand-adjustable float valve 100.

At a step 1725, the threaded portion of the hand-adjustable float valve 100 is screwed into the water inlet of the float chamber or reservoir. For example, the threaded inlet 112 of the valve housing 111 of the valve assembly 110 of the hand-adjustable float valve 100 is screwed into the end of the water supply line 218 of the float chamber or reservoir 212 of the pool system 200. In so doing, the hand-adjustable float valve 100 is installed in the sidewall of the float chamber or reservoir 212 as shown for example in FIG. 16.

At a step 1730, the water supply to the hand-adjustable float valve 100 is turned on. For example, the water supply line 218 to the float chamber or reservoir 212 of the pool system 200 shown in FIG. 2 is turned on.

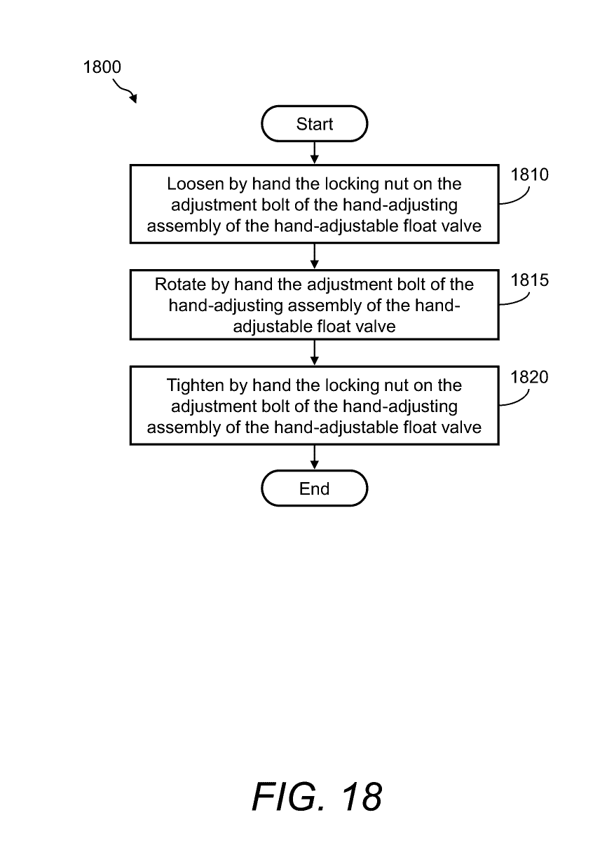

Referring now to FIG. 18 is a flow diagram of an example of a method 1800 of using the presently disclosed hand-adjustable float valve 100 to easily adjust the water level of a pool without the use of tools. The method 1800 may include, but is not limited to, the following steps.

At a step 1810, by hand, the locking nut 166 on the adjustment bolt 152 of the hand-adjusting assembly 150 of the hand-adjustable float valve 100 is loosened. For example, by grasping the locking nut holder 168 with his/her fingers, the user loosens the locking nut 166 on the adjustment bolt 152. Namely, the user rotates the locking nut holder 168 such that the locking nut holder 168 and the locking nut 166 back away from touching the locking plate 186 of the adjustment arm 180.

At a step 1815, by hand, the adjustment bolt 152 of the hand-adjusting assembly 150 of the hand-adjustable float valve 100 is rotated. For example, the user sets the water to the desired level by grasping the adjustment knob 158 on the adjustment bolt 152 with his/her fingers, then rotating the adjustment knob 158 to either advance or retract the adjustment bolt 152 within the adjustment arm 180 and with respect to the float assembly 130.

At a step 1820, by hand, the locking nut 166 on the adjustment bolt 152 of the hand-adjusting assembly 150 of the hand-adjustable float valve 100 is tighten. For example, by grasping the locking nut holder 168 with his/her fingers, the user tightens the locking nut 166 on the adjustment bolt 152 of the hand-adjusting assembly 150. Namely, the user rotates the locking nut holder 168 such that the locking nut holder 168 and the locking nut 166 tighten against the locking plate 186 of the adjustment arm 180 of the hand-adjusting assembly 150.

Referring again to FIG. 1 through FIG. 18, the hand-adjustable float valve 100, the method 1700, and the method 1800 can be used to adjust the water level of a body of water, such as a pool, wherein the change in water level that can be achieved using the hand-adjustable float valve 100 can be, for example, up to about 3½ inches.

Further, in another embodiment, the locking nut 166 and the locking nut holder 168 can be omitted from the hand-adjusting assembly 150 of the hand-adjustable float valve 100. However, this embodiment may require more frequent water level adjustments because the position of the adjustment bolt 152 may tend to move more frequently.

Further, in yet another embodiment, the adjustment arm 180 of the hand-adjusting assembly 150 and the arm 114 of the valve assembly 110 can be integrated into to single member.

Further, while the presently disclosed hand-adjustable float valve 100, the method 1700, and the method 1800 have been described with respect to a swimming pool system, the hand-adjustable float valve 100, the method 1700, and the method 1800 is not limited to use in a swimming pool system only. The hand-adjustable float valve 100, the method 1700, and the method 1800 can be used to maintain the water level of any body of water in any type system. In particular, the size, dimensions, and/or features of the presently disclosed hand-adjustable float valve 100 can be modified for use in any applications in which the level of a body of water must be maintained, as long as the general function of hand-adjusting assembly 150 as described herein is provided.

Aside from an occasional adjustment of water level, the presently disclosed the hand-adjustable float valve 100 can be used for other purposes. For example, in regions in which a pool is filled with “hard water” a line of sediment can sometimes form on the walls of a pool at the high water mark. To remove this sediment line often requires professional cleaning. However, the presently disclosed the hand-adjustable float valve 100 can be used to delay this cleaning event. For example, over time a first sediment line forms at a first water level. Using the hand-adjustable float valve 100, the pool owner can easily raise the water level slightly (e.g., 1 inch) to hide this first sediment line. Then, over time a second sediment line forms at the higher water level. Again, using the hand-adjustable float valve 100, the pool owner can easily raise the water level yet higher (e.g., another 1 inch) to hide the second sediment line. Then, over time a third sediment line forms at the yet higher water level. Perhaps it is when the third sediment line has formed that the pool owner decides to seek professional cleaning to remove the sediment lines. In so doing, the pool owner has saved the expense of cleaning the two previous sediment lines.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. A hand-adjustable float valve comprising:
a. a valve assembly;
b. a float assembly; and
c. a hand-adjusting assembly.

2. The hand-adjustable float valve of “claim” 1 wherein the valve assembly comprises a valve housing that has an inlet and an outlet, an arm for controlling the state of the valve assembly, and a fastener for securing the arm to the valve housing.

3. The hand-adjustable float valve of “claim” 1 wherein the float assembly comprises a float tank coupled to an arm.

4. The hand-adjustable float valve of “claim” 1 wherein the hand-adjusting assembly comprises an adjustment bolt, a locking nut, and an adjustment arm, wherein the adjustment bolt is threaded through the locking nut and through a threaded hole in the adjustment arm.

5. The adjustment bolt of “claim” 4 comprising an adjustment knob affixed to the head thereof wherein the adjustment knob further comprises a grip portion whereby the locking nut can be rotated by hand without the use of tools.

6. The locking nut of “claim” 4 comprising a locking nut holder wherein the locking nut holder further comprises a grip portion whereby the adjustment bolt can be rotated by hand without the use of tools.

7. A method of adjusting by hand (without tools) the water level of a body of water using the hand-adjustable float valve of “claim” 1 wherein the method comprises the steps of:
a. loosening by hand the locking nut on the adjustment bolt of the hand-adjusting assembly of the hand-adjustable float valve;
b. rotating by hand the adjustment bolt of the hand-adjusting assembly of the hand-adjustable float valve; and
c. tightening by hand the locking nut of the hand-adjusting assembly of the hand-adjustable float valve.

8. A pool system comprising the hand-adjustable float valve of “claim” 1.
